(19) United States
(12) Patent Application Publication
(10) Pub. No.: US 2003/0034923 A1
(43) Pub. Date: Feb. 20, 2003

(54) Antenna construction for wireless telephones

(76) Inventor: Chang June Song, Richmond (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/194,579

(22) Filed: Jul. 12, 2002

Related U.S. Application Data
(63) Continuation-in-part of application No. 09/905,487, filed on Jul. 13, 2001.
Application No. 09/905,487 is a continuation-in-part of application No. 09/643,006, filed on Aug. 21, 2000.
(60) Provisional application No. 60/211,836, filed on Jun. 15, 2000.
(60) Provisional application No. 60/164,990, filed on Nov. 12, 1999.

(51) Int. Cl. H01Q 1/24; H01Q 9/30

(52) U.S. Cl. 343/702; 343/900

(57) ABSTRACT

An antenna construction for wireless telephones and the like. The antenna is capable of concentrating electrical fields near one or more antenna points. One antenna construction may have a terminus configured to form a sharp point so that it has a surface diameter that is substantially less than the diameter of the antenna itself. Another construction may use a multi-ended construction, including a number of individual bristles whose terminus will concentrate electrical fields because of its small size. Another construction may be a unitary antenna construction comprises a plurality of elongate arms radiating out from a center. One longitudinal edge of each of the arms is serrated or saw-like, forming the multiple points or ends at which electrical fields may concentrate. The arms are then creased and folded together to form the antenna.

### CROSS REFERENCE TO RELATED APPLICATIONS

This application is a continuation-in-part of U.S. application Ser. No. 09/905,487, entitled “Extendable Antenna for Wireless Telephones,” filed Jul. 13, 2001, which is a continuation-in-part application of U.S. application Ser. No. 09/643,006, entitled “Wireless Phone with Re-Located Antenna and Oscillator,” filed Aug. 21, 2000, which claims the benefit of U.S. Provisional Applications No. 60/164,990 and 60/211,836, respectively filed Nov. 12, 1999 and Jun. 15, 2000, the disclosures of which are hereby incorporated by reference in their entirety.

### BACKGROUND OF THE INVENTION

The present invention relates generally to telecommunication equipment, and more particularly to a wireless telephone with an antenna construction that is more efficient than prior antenna constructions, thereby allowing lower power to be used with a concomitant reduction of possible hair to the user.

Wireless telephones including cell phones have contributed to increased mobile communication by users. When used in the home, wireless telephones allow for freedom of movement while being used. Because these phones are wireless, they are not tied to one location, unlike conventional wire-based telephones. Away from home, wireless telephones may provide instant communicative access to others, allowing one to communicate almost whenever they want and wherever they are.

Unfortunately, the convenience of wireless telephones may come at a price. There are increasing concerns about certain health hazards associated with wireless phone use. Even though the energy emanating from the phone (e.g., the antenna) is relatively small, there is mounting evidence to support these concerns, suggesting that the close proximity of the antenna to a user's head may cause tumors to form on the brain, or cause other genetic damage. Nervousness about the harmful potential of microwaves, which at a distance are considered harmless, but when close to the head, and particularly the ear and brain, are more worrisome, has caused the FCC to regulate the amount of energy that wireless phones are allowed to emit.

Although the industry continues to maintain that all cell phones sold in the United States meet government regulations and are safe, many sources continue to be troubled about the energy emitted by wireless telephones. This continuing concern has prompted the Cellular Telecommunications Industry Associates (“CTIA”) to require those cell phone manufacturers who wish to be certified by CTIA to submit radiation data.

### BRIEF SUMMARY OF THE INVENTION

A first embodiment of the present invention discloses an antenna construction for wireless telephones, although the design may also be used for other communication devices. The invention relies on the fact that a highly concentrated electrical field may exist near an electrode point. This fact is used to construct an antenna that is more efficient, allowing the use of lower power and a concomitant lower risk of wireless telephone hazards.

Broadly, a first embodiment of the present invention is an antenna construction having a terminus configured to form a sharp point so that it has a surface diameter that is substantially less than the diameter of the antenna itself. Another embodiment may be a multi-ended construction. This construction uses an antenna of brush-like design that includes a number of individual bristles whose terminus will concentrate electrical fields because of its small size. Another embodiment is a unitary antenna construction that comprises a plurality of elongate arms radiating out from a center. One longitudinal edge of each of the arms is serrated or saw-like, forming the multiple points or ends at which electrical fields may concentrate. The arms are then creased and folded together to form the antenna.

The antenna constructions of the present invention provide several advantages. First, by concentrating the electrical field for either incoming or outgoing RF (radio frequency) transmissions at one or more points, an antenna that is much more efficient is achieved, and further provides less outgoing or incoming signal strength relative to conventional antennas. The ability to use less signal strength thereby lessens the RF energy to which a user is subjected, thus lessening any harm that may be caused.

A further understanding of the nature and advantages of the present invention herein may be realized by reference to the remaining portions of the specification and the attached drawings. References to “steps” of the present invention should not be construed as limited to “step plus function” means, and are not intended to refer to a specific order for implementing the invention. Further features and advantages of the present invention, as well as the structure and operation of various exemplary embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 is an illustration of a wireless telephone incorporating an antenna construction according to one embodiment of the invention;

FIG. 2A is a view of the antenna of the wireless telephone of FIG. 1 in greater detail, illustrating the tapered exterior end;

FIG. 2B illustrates encapsulation of the antenna of FIG. 2A in a material transparent to RF energy to protect the tapered end of the antenna;

FIG. 3A is an illustration of an alternate embodiment of the invention in the form of a multi-end antenna;

FIG. 3B is a top plan view of the antenna shown in FIG. 3A;

FIG. 4A is a further embodiment of the antenna construction of the present invention;

FIG. 4B is a perspective view of the antenna construction of FIG. 4A in assembled form;

FIG. 5 is another embodiment of an antenna construction incorporating the teachings of the present invention;

FIG. 6A is an exemplary embodiment of the antenna of FIG. 1; and

FIG. 6B is a top plan sectional view of the antenna of FIG. 6A taken along the view line 6B-6B.

### DETAILED DESCRIPTION OF THE INVENTION

FIG. 1 is an illustration of a representative wireless telephone 10 having an antenna 12 structured according to one embodiment of the invention.

As is conventional, wireless telephone 10 is constructed to have an outer shell or case 20 which will contain the necessary electronic circuitry (not shown) for operation. As FIG. 1 shows, wireless telephone 10 carries a keypad 22, display, such as a liquid crystal element, 24, an aperture 26 for ingress of aural energy to the microphone (not shown), and an earpiece 28 for egress of sound produced by, for example, a speaker (not shown) of wireless telephone 10.

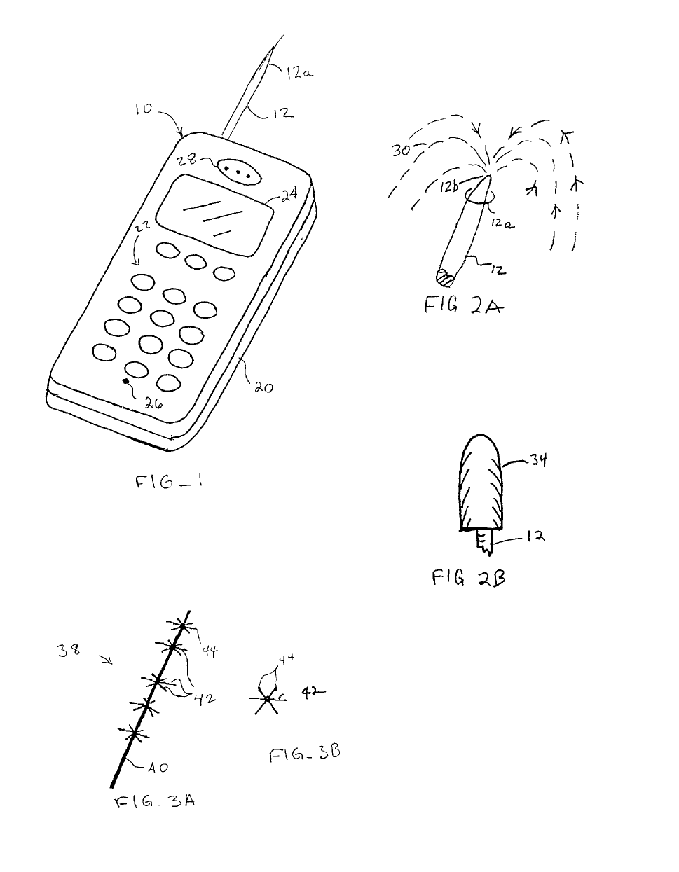

FIG. 2A is a view of the antenna of the wireless telephone of FIG. 1 in greater detail, illustrating a tapered exterior end 12a.

As shown, the antenna 12 is constructed to have a taper 12a that narrows to a pointed end 12b having a surface diameter substantially less than the diameter of antenna 12. This construction causes a concentration of field lines 30 to occur at tip 12b that relies on peak discharge principles to facilitate transmission and reception of radio waves (e.g., RF energy). Although not shown, one of ordinary skill in the art will realize that any construction capable of causing a concentration of field lines may be used by the present invention.

FIG. 2B shows illustrates encapsulation of antenna 12 of FIG. 2A in a material transparent to RF energy to protect the tapered end of the antenna. A material 34 that may allow RF energy to reach point 12b may be used to cover the point 12b of the antenna 12. For example, material 12 may be an elastomeric polymer such as plastic. Other materials such as glass and the like may be employed as well. Further, material 34 may be transparent or translucent to enhance receipt of RF energy by the point 12b.

FIG. 3A illustrates an antenna 38 that is an alternate embodiment of antenna 12 of FIG. 1.

Among other components, antenna 38 comprises an elongate body 40 from which a plurality of electrically conductive filaments 42 are formed. Conductive filaments 42 each end in a small point 44. Depending upon the wireless technology involved, antenna characteristics such as the antenna length, the filament length and the distance between filament groups may vary. Filaments 42 provide points at which electric fields may concentrate, improving RF reception and transmission of the wireless phone using the antenna 38.

FIG. 3B is a top plan view of the antenna shown in FIG. 3A.

As shown, conductive filaments 42 are radially spaced around the circumference of antenna 38. The radial spacing may be partial and need not extend around the entire circumference of the antenna 38. Each conductive filament 42 may be longer than the preceding or next filament. Further, the angles between two adjacent conductive filaments may vary around the antenna circumference.

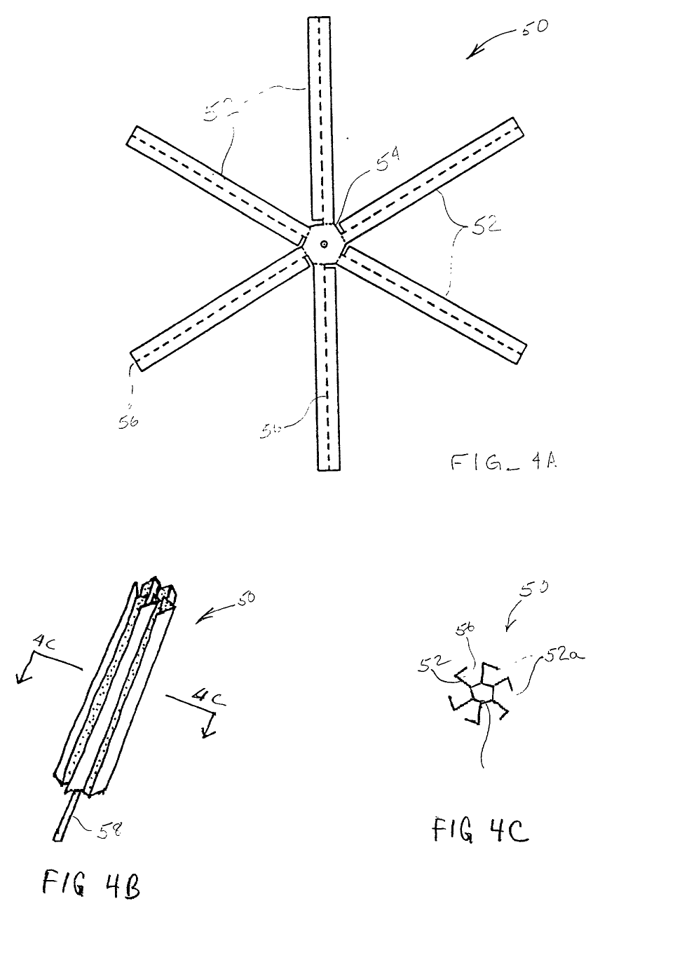

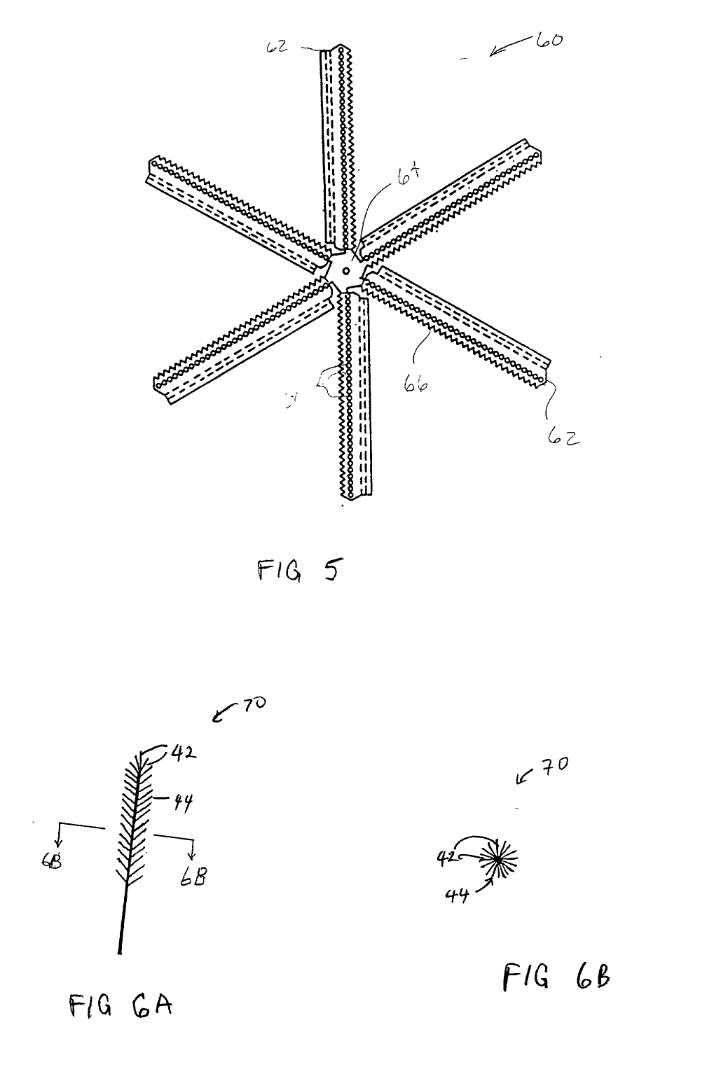

FIG. 4A is an exemplary alternate embodiment of antenna 12 of FIG. 1.

In FIG. 4, an antenna construction 50, before assembly, includes a plurality of arms 52 that are integral with and extend out from a centerpiece 54. Entire antenna construction 50 is preferably formed from a thin sheet of metallic or other electrically conductive material. Each arm has a fold line 56 so that the arm may be bent slightly to provide each arm with a modicum of structural integrity. Antenna construction 50 is formed by first folding each arm slightly about the fold line. Then, the arms are folded toward one another to form antenna construction 50 shown in FIG. 4B.

FIG. 4B is a perspective view of the antenna construction of FIG. 4A in assembled form. The antenna construction is mounted to an elongate base element 58 for connection to a wireless telephone and its associated electronic circuitry.

FIG. 4C is a top plan sectional view of the antenna construction of FIG. 4B taken along the view line 4C-4C, showing the folding of each of arms 52 about the fold lines 56 and the finished construction of the antenna 50. Arms 52 are, as indicated, formed from a thin material so that the outer edges 52a are relatively sharp. Edges 52a provide a means for concentrating electrical field lines for enhancing the efficiency of RF transmission and reception according to the teachings of the present invention.

FIG. 5 is a further exemplary embodiment of antenna 50 of FIG. 4A.

In FIG. 5, there is shown an antenna 60 that is similar to antenna 50 in that antenna 60 is constructed from a flat, thin material to form a number of arms 62 integral with and extending from a centerpiece 64. One longitudinal edge 66 of each arm 62 is serrated to form a number of relative sharp points for electric field concentration thereat? In addition, each arm 62 is provided a linear string of apertures 68 to facilitate partial folding of the arm to add structural integrity thereto.

Antenna 60 is assembled in a similar manner as antenna 50. The arms 62 are folded lightly (i.e., to form a 90 degree or less bend) to add structural integrity. Then, arms 62 are bent at their junction to centerpiece 64 toward one another to form the antenna structure similar to that shown in FIG. 4B. Antenna 60 is attached or otherwise affixed to an elongate base member (not shown) like 58 (FIG. 4B) for use with a wireless telephone or other communicating device.

FIG. 6A is an antenna 70 that is an exemplary embodiment of antenna 12 of FIG. 1.

As shown, the electrically conductive filaments 42 are densely located along the elongate antenna body 40, similar to a round brush-like structure. The electrically conductive filaments may be located partially or completely along antenna body 40. By providing relatively more filaments, higher concentrations of RF field lines may be obtained.

FIG. 6B is a top plan sectional view of antenna 70 of FIG. 6A taken along the view line 6B-6B. As shown, electrically conductive filaments 42 are radially spaced around the circumference of antenna 70. The radial spacing may be partial and need not extend around the entire circumference of the antenna 70. Each filament may be longer than the preceding or next filament. Further, the angles between two adjacent filaments may vary around the antenna circumference.

In this fashion, the present invention provides an antenna construction not only for wireless telephones, but also for other signal receiving and transmitting devices. While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. An antenna for use with wireless telephones, comprising:
an elongate antenna base, the antenna base being formed and configured to have a plurality of points at which an electromagnetic field may concentrate.

2. The antenna of claim 1, wherein the plurality of points is formed by a plurality of bristles.

3. The antenna of claim 1, wherein the antenna base includes a plurality of bristles emanating therefrom, the terminus of each of the plurality of bristles forming each of the plurality of points.

4. The antenna of claim 1, the antenna base being formed from an elongate, flat metal having a longitudinal serrated edge, the serrated edge being configured to form the plurality of points.

5. An antenna, comprising:
an elongate, electrically conductive member; and
a plurality of points formed on the conductive member, each of the plurality of points being configured to concentrate electrical field lines.

6. An antenna, comprising:
an elongate member having first and second ends, the first end forming a point having a surface diameter substantially smaller than the mean diameter of the elongate member, the second end being configured to be coupled to a transmitting or receiving device.

7. The antenna of claim 6, wherein the elongate member is substantially cylindrical.

8. The antenna of claim 6, including a material that is substantially transparent to electrical waves formed on the elongate member and encompassing the first end.

9. The antenna of claim 8, wherein the material is a plastic.

10. A method of using an antenna, the method comprising:
providing an elongate, electrically conductive member, having a plurality of points formed on the conductive member;
attaching the electrically conductive member to a telephone; and
configuring each of the plurality of points to concentrate electrical field lines to facilitate transmission and reception by the telephone.

11. A method of constructing an antenna, comprising:
providing an elongate member having first and second ends;
forming a point on the first head, the point having a surface diameter substantially smaller than the mean diameter of the elongate member; and
configuring the second end to be coupled to a transmitting or receiving device.
